(19) United States
(12) Patent Application Publication
(10) Pub. No.: US 2013/0151372 A1
(43) Pub. Date: Jun. 13, 2013

(54) ITEM EXCHANGE USING LOCATION INFORMATION

(71) Applicant: Qian Liu, San Jose, CA (US)

(72) Inventor: Qian Liu, San Jose, CA (US)

(73) Assignee: eBay Inc., San Jose, CA (US)

(21) Appl. No.: 13/430,102

(22) Filed: Mar. 26, 2012

Related U.S. Application Data
(60) Provisional application No. 61/568,621, filed on Dec. 8, 2011.

(51) Int. Cl. G06Q 30/00

(52) U.S. Cl. 705/26.9; 705/27.1

(57) ABSTRACT

An apparatus and method are provided herein for a plurality of users to barter, exchange, or trade goods and/or services with each other. One item may be exchanged for one or more items in a given barter transaction. Conversely a plurality of items may be exchanged for another plurality of items in a given barter transaction. A user interface is provided for a user to submit an item to the system to be made available for exchange, request one or more matching items suitable for exchange for the submitted item, and once the user has selected an item from among the matching items to exchange with the submitted item, a message is sent to a user associated with the selected item requesting an exchange of the submitted item for the selected item

### CROSS-REFERENCE TO RELATED APPLICATIONS

The present application claims priority to U.S. Provisional Patent Application No. 61/568,621 filed Dec. 8, 2011 (Attorney docket no. 2043.A07PRV), the content of which is incorporated herein by reference in its entirety.

### TECHNICAL FIELD

The present application relates generally to systems and methods for electronic coordination of exchange or barter of items.

### BACKGROUND

All of us have goods or products that we no longer want for a variety of reasons. We are then left with several disposal options. We can donate the goods, throw it away, sell it, or trade it for one or more different goods. With trading (also referred to as bartering), it is typically done in-person and on an ad hoc basis. Bartering comprises a transaction between two parties, but it is different from a sales transaction (even a used goods sales transaction). Among other things, bartering involves assigning value to at least two goods, typically used goods, and each of the potentially exchanging parties is required to come to an agreement as to the value of all goods being exchanged between them and that the values are relatively equal to each other in order for the barter to be completed. Moreover, because bartering is typically conducted face-to-face and on an ad hoc basis, only a few persons may know about a given product available for barter.

Bartering using an electronic system has benefits such as a given product potentially having exposure to a wider audience. However, electronic systems tend to be impersonal which is counter to the personal nature of bartering.

### BRIEF DESCRIPTION OF THE DRAWINGS

Some embodiments are illustrated by way of example and not limitations in the figures of the accompanying drawings, in which:

FIG. 1 illustrates a network diagram depicting an example system for providing an item(s) matching mechanism for barter, exchange, or trade according to some embodiments.

FIG. 2 illustrates a block diagram of additional details of applications included in the system of FIG. 1 according to some embodiments.

FIG. 3 illustrates a block diagram showing the barter mechanism implemented in modules according to some embodiments.

FIGS. 4A-4C illustrate an example flow diagram showing the functionalities or operations of the barter mechanism according to some embodiments.

FIGS. 5A-5K illustrate example user interface (UI) screens provided on the device machines of FIG. 1 associated with the barter mechanism according to some embodiments.

FIG. 6 illustrates a diagrammatic representation of a machine in the example form of a computer system within which a set of instructions, for causing the machine to perform any one or more of the methodologies of FIG. 3, 4A-4C, or 5A-5K according to some embodiments.

The headings provided herein are for convenience only and do not necessarily affect the scope or meaning of the terms used.

### DETAILED DESCRIPTION

Described in detail herein is an apparatus and method for a location based mobile application (also referred to as an “app”) that allows people to exchange, trade, or barter everyday items or skills/services of perceived equal value. The app is a sophisticated matching system that allows people an alternative to discarding their items and connects them with other like-minded individuals interested in being a part of a mobile bartering community that recycles unused items in an efficient and low maintenance way. The app helps budget-conscious individuals find useful goods and services of interest to them and to also find related “hidden gem” products of similar value that they may not have thought to search for. As users develop search habits, the system will retrieve not only results of items directly related to what was searched for, but also results of items indirectly related to the search, such as products in the same price/value range or in the same descriptive genre.

The following description is presented to enable any person skilled in the art to create and use a computer system configuration and related method and article of manufacture to receive items for inclusion in an exchange, present item(s) already in the exchange that match (or nearly match) an item wished to be traded, and provide a mechanism to decide between presented matching items and complete a trade with the owner of the selected matching item. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

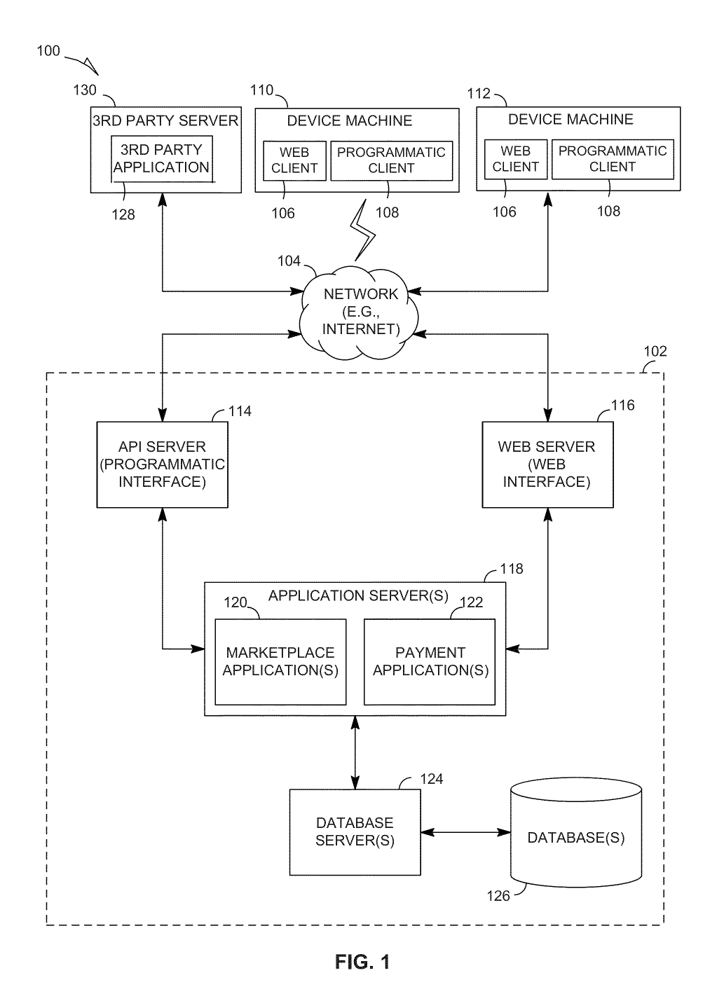

FIG. 1 illustrates a network diagram depicting an example system 100 for providing an item(s) matching mechanism for barter, exchange, or trade according to some embodiments. A networked system 102 forms a network-based publication system that provides server-side functionality, via a network 104 (e.g., the Internet or Wide Area Network (WAN)), to one or more clients and devices. FIG. 1 further illustrates, for example, one or both of a web client 106 (e.g., a web browser) and a programmatic client 108 executing on device machines 110 and 112. In one embodiment, the publication system 100 comprises a barter or exchange system. In another embodiment, the publication system 100 comprises other types of systems such as, but not limited to, a marketplace system, a social networking system, a matching system, and the like.

Each of the device machines 110, 112 comprises a computing device that includes at least a display and communication capabilities with the network 104 to access the networked system 102. The device machines 110, 112 comprise, but are not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like. Each of the client machines 110, 112 may connect with the network 104 via a wired or wireless connection. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the device machines 110, 112 includes one or more applications (also referred to as “apps”) such as, but not limited to, a web browser, messaging application, electronic mail (email) application, a barter mechanism described herein, and the like. In some embodiments, if the barter mechanism is included in a given one of the device machines 110, 112, then this mechanism is configured to locally provide the user interface and at least some of the functionalities with the mechanism configured to communicate with the networked system 102, on an as needed basis, for data and/or processing capabilities not locally available (such as access to a database of items available for trade or to authenticate a user). Conversely if the barter mechanism is not included in a given one of the device machines 110, 112, the given one of the device machines 110, 112 may use its web browser to access the barter mechanism (or a variant thereof) hosted on the networked system 102. Although two device machines 110, 112 are shown in FIG. 1, more or less than two device machines can be included in the system 100.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of barter functions and services to users that access networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products or items (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102. In other embodiments, the payment applications 122 may be omitted from the system 100.

Further, while the system 100 shown in FIG. 1 employs a client-server architecture, embodiments of the present disclosure is not limited to such an architecture, and may equally well find application in, for example, a distributed or peer-to-peer architecture system. The various marketplace and payment applications 120 and 122 may also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

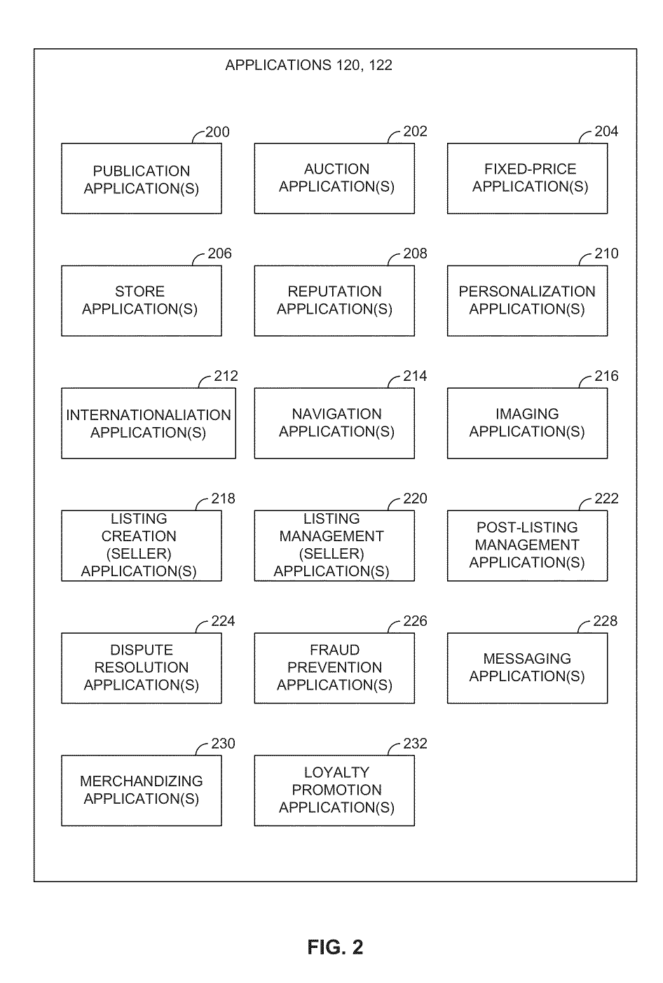

FIG. 2 illustrates a block diagram of additional details of applications 120 and 122 according to some embodiments. Applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications or so as to allow the applications to share and access common data. The applications may furthermore access one or more databases 126 via the data servers 128.

The networked system 102 may provide a number of publishing, listing, and/or price-setting mechanisms whereby a seller (also referred to as a first user) may list (or publish information concerning) goods or services for sale or barter, a buyer (also referred to as a second user) can express interest in or indicate a desire to purchase or barter such goods or services, and a transaction (such as a trade) may be completed pertaining to the goods or services. To this end, the marketplace applications 120 are shown to include at least one publication application 200 and one or more auction applications 202 which support auction-format listing and price setting mechanisms (e.g., English, Dutch, Vickrey, Chinese, Double, reverse auctions, etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users that transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user, for example through feedback provided by other transaction partners, to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace, or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. An example of a navigation application 214 comprises a search application that may enable key word searches of listings published via the networked system 102. A browse application may allow users to browse various category, catalogue, or inventory data structures according to which listings may be classified within the networked system 102. Various other navigation applications may be provided to supplement the search and browsing applications.

In order to make listings, available via the networked system 102, as visually informing and attractive as possible, the marketplace applications 120 may include one or more imaging applications 216 utilizing images that users may upload for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers conveniently to author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occurs post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such messages include, for example, advising users regarding the status of listings at the networked system 102 (e.g., providing “no barter” notices to a user that requested a barter to another user, or to provide promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotions points for each transaction established and/or concluded with a particular seller, and may be offered a reward for which accumulated loyalty points can be redeemed.

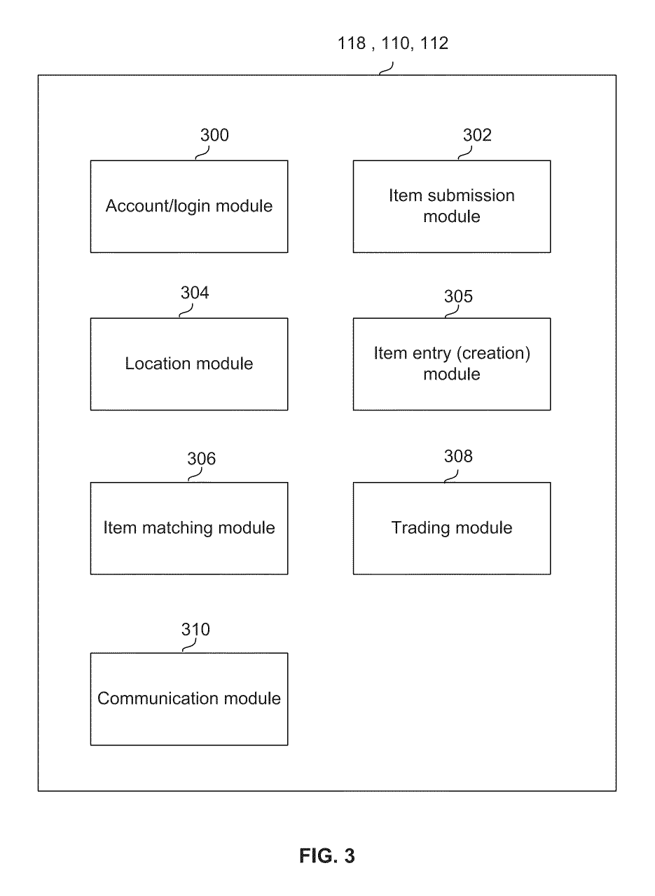

FIG. 3 illustrates a block diagram showing the barter mechanism implemented in modules, the modules implemented in the application servers 118, device machine 110, and/or device machine 112 according to some embodiments. The modules comprise one or more software components, programs, applications, apps, or other units of code base or instructions configured to be executed by one or more processors included in the application servers 118, device machine 110, and/or device machine 112 to provide the functionalities or operations of the barter mechanism. In some embodiments, the modules are downloaded from an ecommerce site appropriate for the type of computing device. For example, if the device machine 110 (or device machine 112) comprises an iOS-type device (e.g., iphone or the ipad), then the modules (which can be packaged as a bartering app) can be downloaded from iTunes. Similarly, if the device machine 110 (or device machine 112) comprises an Android-type device, then the modules can be downloaded from the Android Marketplace. The device machine 110 and/or device machine 112 has communication capabilities with servers or databases at a remote location (e.g., databases 126, database servers 124, API server 114, web server 116) to access information about other items submitted for barter, to obtain matching results, to facilitate communication and notification among the users, and the like, as needed by the barter mechanism.

In other embodiments, the modules may be hosted on the application servers 118 and no download of the modules is required on the device machines 110, 112; instead the modules may be accessed by device machines 110, 112 using a web browser over the network 104. In still other embodiments, some of the modules may be included in the device machines 110, 112 while other of the modules may be included in the application servers 118; the device machines 110, 112 communicating with the application servers 118 to together provide the functionalities of the barter mechanism. Although modules 300-310 are shown as distinct modules in FIG. 3, it should be understood that modules 300-310 may be implemented as fewer or more modules than illustrated. It should also be understood that any of modules 300-310 may communicate with one or more components included in the system 100, such as database servers 124, application servers 118, device machine 110, or device machine 112. The modules include an account/login module 300, an item submission module 302, a location module 304, an item entry (creation) module 305, an item matching module 306, a trading module 308, and a communication module 310.

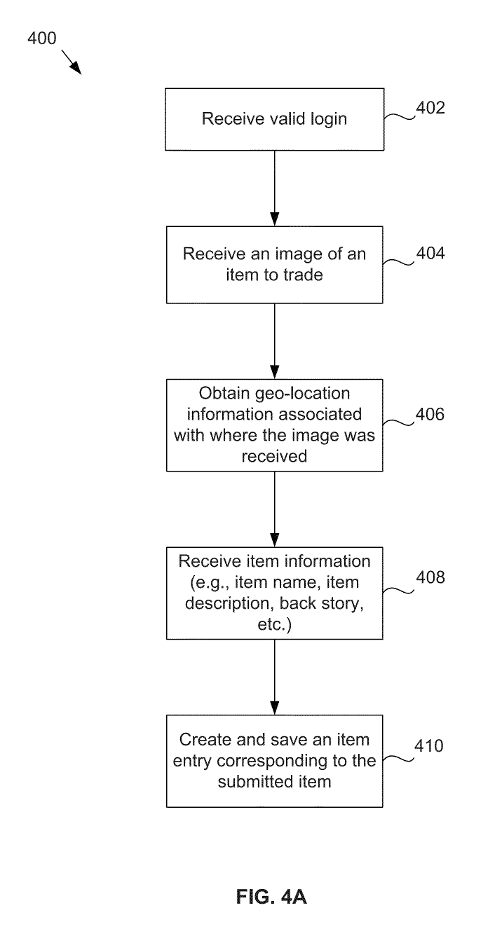

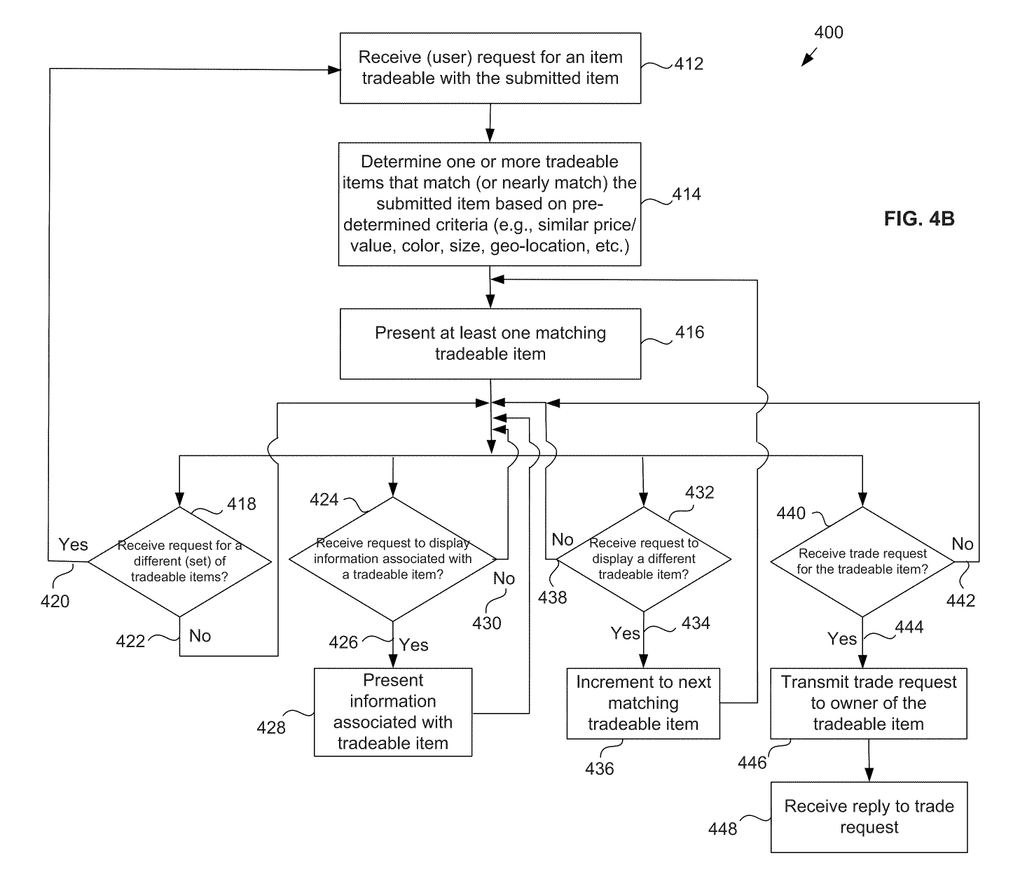

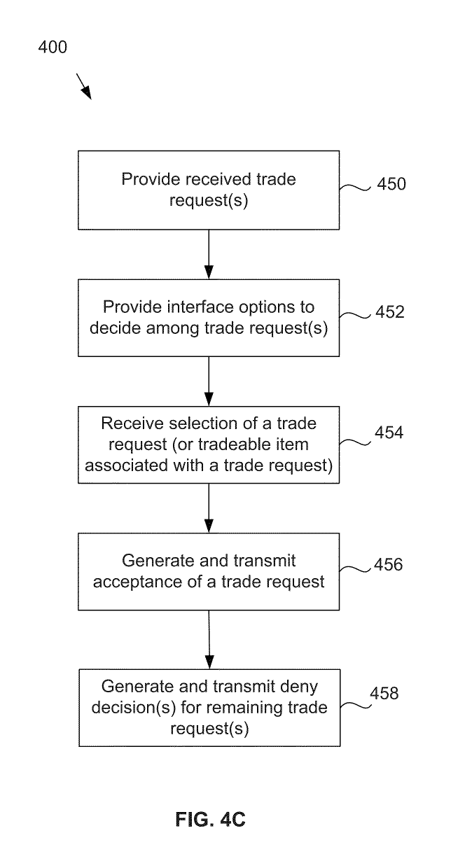

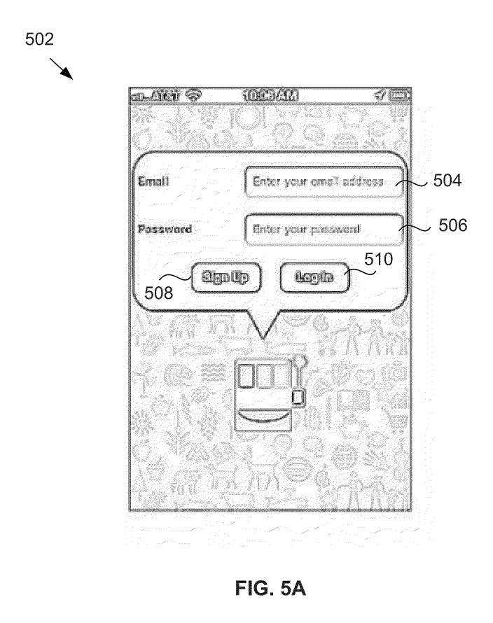

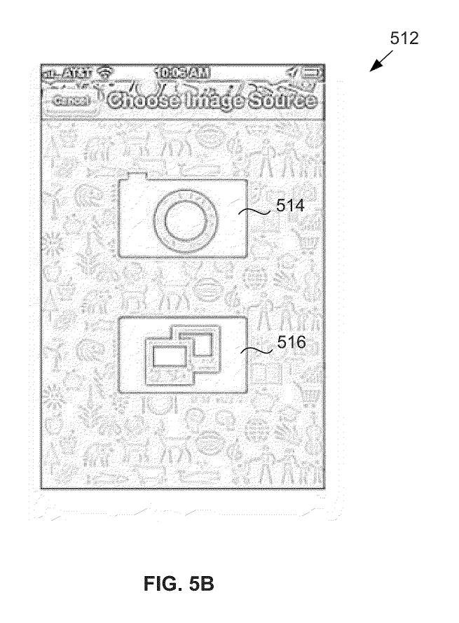

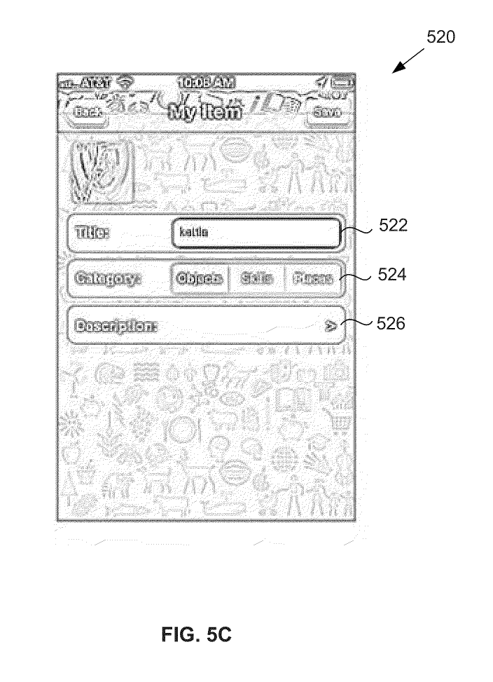

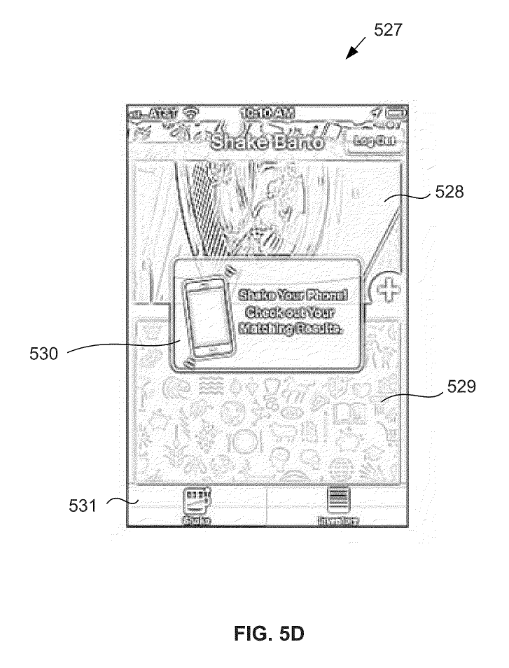

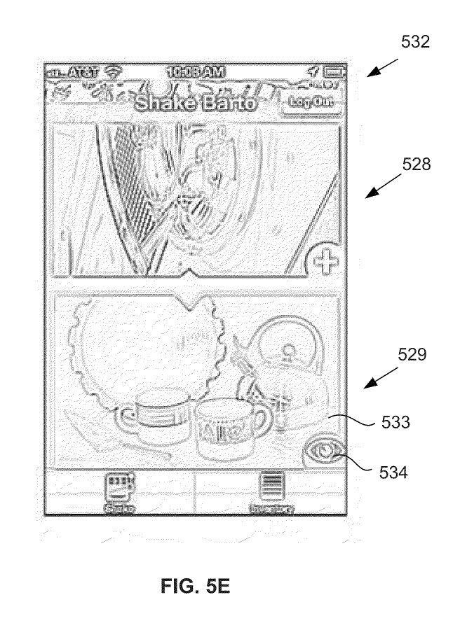

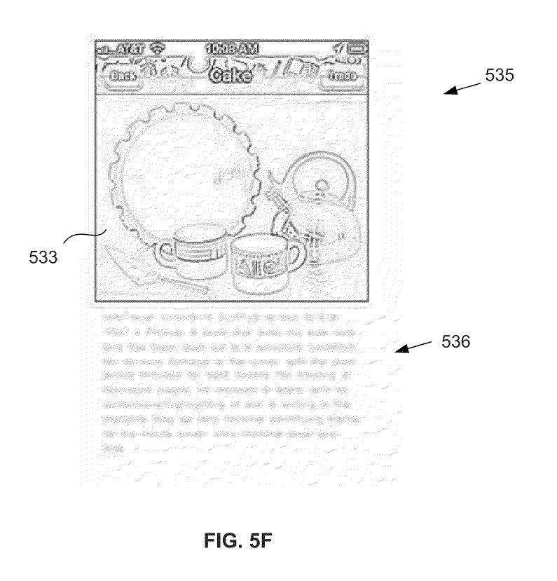

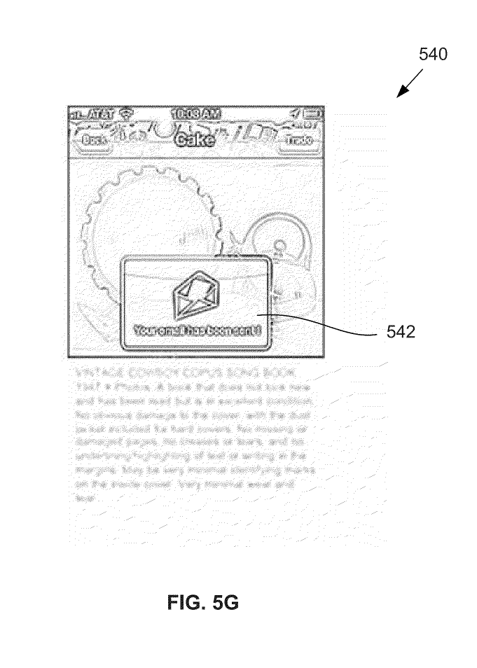

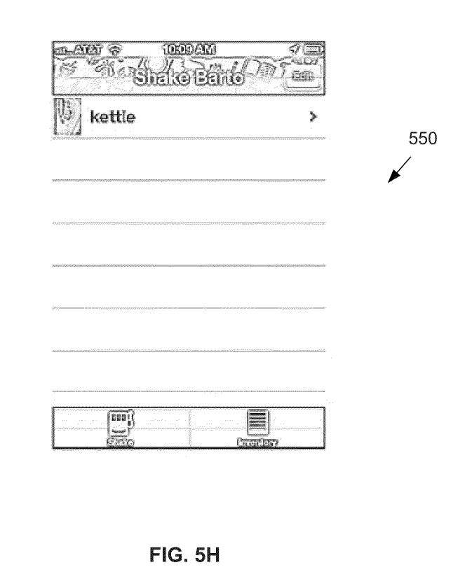

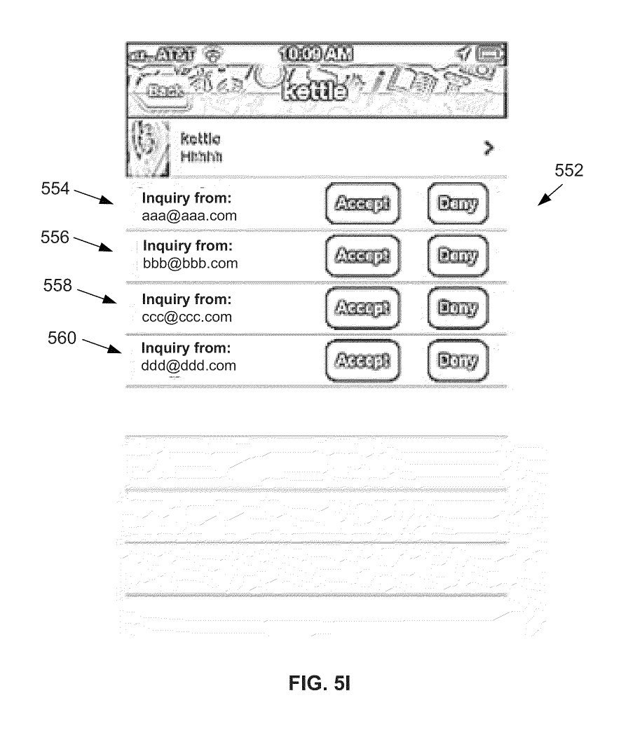

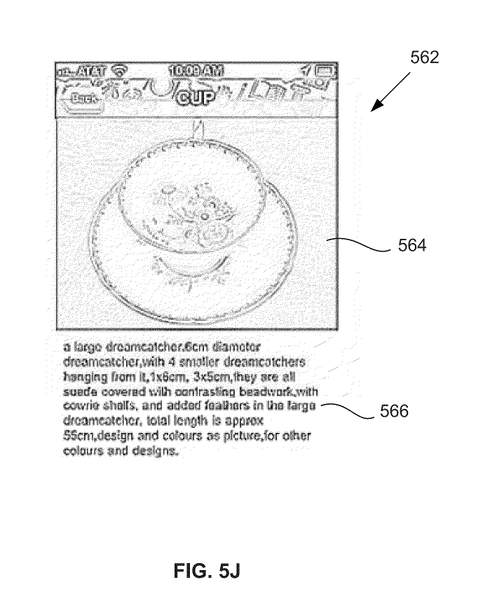

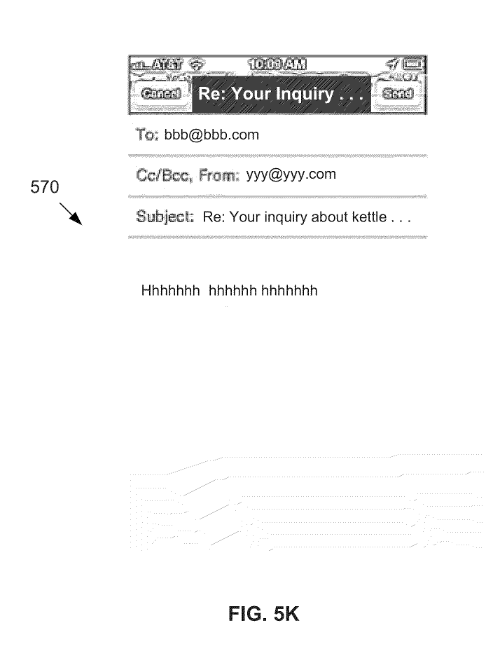

FIGS. 4A-4C respectively illustrate portions of an example flow diagram 400 showing the functionalities or operations of the barter mechanism according to some embodiments. FIGS. 5A-5K illustrate example user interface (UI) screens provided on the device machines 110, 112 associated with the barter mechanism according to some embodiments. FIGS. 3, 4A-4C and 5A-5K are described below in conjunction with each other to describe one or more embodiments of the barter mechanism. The barter mechanism disclosed herein facilitates bartering, exchanging, or trading goods and/or services (collectively referred to as “items”) between a plurality of users. The barter mechanism is also referred to as an item barter mechanism, a bartering mechanism, an item exchange mechanism, an exchange mechanism, an item trade mechanism, a trading mechanism, and similar terms.

A first user accesses the barter mechanism on the device machine 110 (e.g., a first device). Depending on where the application(s) corresponding to the barter mechanism resides, it may be directly launched on the device machine 110 as an app or launched via a web browser included in the device machine 110. It is understood that the first user can alternatively access the barter mechanism on the device machine 112.

At a block 402 of FIG. 4A, the device machine 110 presents a login screen 502 to verify the first user's right to access the barter mechanism. If the first user is accessing for the first time (or has not previously registered or established an account), then the first user can enter his/her email address and a password into respectively a username field 504 and a password field 506 and then actuate a sign up button 508. The sign up process includes receiving basic information from the first user such as, but not limited to, name, address, phone number, and other information that may be useful in facilitating bartering items with one or more other registered users. If the first user has previously established an account, he/she can enter an email address and password, and then actuate a log in button 510. An account/login module 310 is configured to receive the login information from the first user.

Next at a block 404, an item submission module 302 is configured to receive an image of an item that the first user wishes to barter, trade, or exchange for one or more other items. FIG. 5B shows an image request screen 512 provided on the device machine 110 requesting the first user to choose an image capture source. The image request screen 512 provides a choice between a camera source 514 and an image file storage source 516. If the camera source 514 is selected, the item submission module 302 is configured to provide camera functionalities/interface on the device machine 110 (either as a part of the same app or by launching a separate app (e.g., a camera app), so that the first user can take a photo of the item. The photo of the item is stored in a database or repository of item images (e.g., databases 126). If the image file storage source 516 is selected, the item submission module 302 is configured to facilitate transfer of an image file corresponding to the item being submitted from a storage source/location to a database/repository of item images (e.g., databases 126). It is understood that an image of an item comprises a static image, photograph, drawing, video, and other visual information associated with the item being submitted.

Once an image of the item has been received, a location module 304 is configured to obtain or determine geographical location information (also referred to as geo-location information) associated with where the image was received (block 406). In other words, the geographical location of the device machine 110 when the image was received. Geographical location information is obtained in one or more ways: using the global positioning system (GPS) included in the device machine 110, triangulation using cellular base stations when the device machine 110 comprises a cellular network device, or the first user's input of the geo-location (e.g., zip code, cross roads, address, city, county).

Next at a block 408, the item submission module 302 is configured to receive information about the item from the first user. FIG. 5C shows an item information entry screen 520 provided on the device machine 110 including one or more fill-in fields such as, but not limited to, an item name or title field 522, an item category designation field 524, and an item description field 526. Other information relating to the item can also be received from the first user, such information facilitating other users to choose trading one or more of their items for the first user's item. Thus, item information comprises, but is not limited to, an item name, item description (e.g., color, dimensions, original price), item category (e.g., a good, a service, a place), background or back story, reason for bartering the item, and the like.

An item entry (creation) module 305 is configured to create and save a new item entry corresponding to the first user's submitted item in an appropriate database or repository (e.g., databases 126) (block 410). The item entry comprises at least the received item image, geo-location information, item information, and association with the first user identifier (e.g., first user's email address). The item entry (creation) module 305 and/or additional computing devices (e.g., database servers 124, application servers 118) may also process the information corresponding to the submitted item to determine derived information useful for finding relevant matching items to the submitted item. For example, the submitted item can be further classified into one or more classifications (e.g., classify or group items by different types of items (clothing, shoes, accessories, transportation, furniture, electronic, etc.), price ranges, etc.) to facilitate matching relevancy and/or time to run a matching search. The item entry (creation) module 305 and/or additional computing devices (e.g., database servers 124, application servers 118) can analyze key words in the first user's inputted information about the submitted item or use image recognition software to obtain information from the item image. Database record keeping-type information, such as an item entry identifier, time/date stamp, and the like, is also associated with the item entry. Thus, the saved item entry can include information provided by the first user and one or more backend system-type (or derived) information.

Note that a given item submission can comprise submission of one or more items. For example, if the first user wishes to barter two items together as a unit for some other item, then those two items are submitted together as a single submission. The image of the item would show both items together, the item description would include descriptions of both of the items, and the like.

FIG. 4B illustrates a portion of the flow diagram 400 associated with one or more items found to match the first user's submitted item. The first user submits an item using the device machine 110 in FIG. 4A, and then the first user requests (and interacts with) items matching the submitted item using the device machine 110 in FIG. 4B. In one embodiment, the first user submits the item into the system and requests matching items (block 412) in the same session on the bartering system. In another embodiment, the first user submits the item in a session different from the session in which he/she requests matching items (block 412).

At the block 412, the first user's request for other users' items that are available for trade with his/her submitted item is received by the device machine 110. When the device machine 110 comprises a mobile device including sensor(s) capable of detecting or sensing device movement, the device machine 110 is configured to detect device movement that comprises a pre-determined movement. The pre-determined movement (also referred to as a pre-determined device movement or pre-determined motion), in some embodiments, comprises back-and-forth movement generally along an axis or back-and-forth tilting movement, such as a shaking motion. Such pre-determined movement can be sensed by an accelerometer included in the device machine 110. Alternatively, even for such a mobile device, the first user can alternatively actuate a button or icon provided on the device machine 110 to achieve the same request.

FIG. 5D shows an example match request screen 527 provided at the device machine 110. The match request screen 527 comprises two (vertically aligned) windows or a partitioned display format—a top portion 528 and a bottom portion 529. The top portion 528 displays an image of the first user's submitted item (e.g., displays the previously submitted item image corresponding to the submitted item). The bottom portion 529 is presently left blank to be filled with images of matching item(s). The match request screen 527 further includes an area 530 configured to instruct and/or notify the first user what to do to request matching item(s): “Shake your phone! Check out your matching results.” The first user shakes the device machine 110 while the match request screen 527 is displayed to request matching item(s). The match request screen 527 also includes a shake icon or button 531 that can be actuated (e.g., touching the button 531 on a touch screen of the device machine 110), as another way to initiate requesting matches. This feature may be used by devices that do not recognize shaking as a match requesting command.

Upon detection of shaking or actuation of the shake button 531 (or some other valid command to find matches), an item matching module 306 is configured to facilitate determining and returning matching results to the device machine 110 (block 414). In some embodiments, the item matching module 306 is configured to determine one or more of other users' items available for (immediate) trade that match (or nearly match) the first user's submitted item in accordance with pre-determined criteria. In other embodiments, the item matching module 306 is configured to provide at least an identifier of the first user's submitted item and a command to return matching results to the networked system 102 via the network 104.

The pre-determined criteria comprises one or more matching (or nearly matching within a certain margin) criteria such as, but not limited to, geo-location, size, price/value, color, classification, skill, and the like. In one embodiment, the pre-determined criteria comprises just matching (or near matching) geo-location. In another embodiment, the pre-determined criteria comprise geo-location and one or more of the other pre-determined criteria (e.g., size, price/value, color, classification). One advantage of searching for matching items based on at least the same geo-location is that if the parties agree to trade items with each other, items do not need to be shipped. (In some cases, the cost of shipping may exceed the cost of the items, making trading such items undesirable.) Examples of same geo-locations include same zip code, same city, same metro area, same county, same neighborhood, or other designated area that is close enough that trading users are likely to make the trade in person with each other. In still another embodiment, the pre-determined criteria may be a random selection (which facilitates all items in the database having an equal chance for screen time). In yet another embodiment, the pre-determined criteria may be a semi-random selection such as random selections except limited by the same or nearly the same geo-location.

It is also contemplated that if the number of matching results is too few or too many, a secondary or additional set of pre-determined criteria may be used to obtain a reasonable number of final matching results. Depending on the number of items available for trade, it is possible, for example, that the default set of pre-determined criteria may initially return zero items. In such case, another set of pre-determined criteria may be used to obtain at least one matching item.

Once matching results (also referred to as tradeable items or matching items) have been determined, the item matching module 306 is configured to present such matching results on the device machine 110 (block 416). In some embodiments, the matching results are presented one item at a time, with the presentation order corresponding to the degree of match between a given matching item with the first user's submitted item. FIG. 5E illustrates a matching results presentation screen 532 including the top portion 528 and bottom portion 529. The top portion 528 continues to display an image of the first user's submitted item (e.g., a kettle). The bottom portion 529 is configured to display an item image 533 of a given one of the matching items (e.g., a kettle, cups, a plate and a pie server). The item image 533 was previously submitted along with its corresponding item information and geo-location information by the owner of that item (similar to blocks 402-410).

Upon viewing a matching item, the first user has several response options at the device machine 110. If the first user has reviewed the matching results and does not find a satisfactory tradeable item, he/she can request more matching tradeable item(s) (e.g., request another set of matching results) (block 418 and yes branch 420). In response, the item matching module 306 is configured to conduct a matching search against item submissions stored in the databases 126 using at least one different criterion than used in the previous matching search. The new matching results are presented on the device machine 110 as described above and the first user again has the full range of response options. Otherwise the device machine 110 is configured to wait for a command from the first user (no branch 422).

The device machine 110 is configured to receive requests for information about the matching tradeable item(s) (block 424). If the first user wishes to obtain item information corresponding to the currently displayed matching tradeable item, for example, the item image 533 (FIG. 5E), he/she actuates an information icon or button 534 included in the matching results presentation screen 532 (yes branch 426). In response at a block 428, the item matching module 306 is configured to present an item information screen 535 corresponding to that item. FIG. 5F shows the item information screen 535 including the item image 533 and item information 536 (e.g., information provided in the item description field 526 for that item). Otherwise the device machine 110 is configured to wait for a command from the first user (no branch 430).

The device machine 110 is configured to receive requests to display another of the tradeable item(s) from among the matching results (block 432 and yes branch 434). The command received from the first user includes, but is not limited to, shaking the device machine 110 when the matching results presentation screen 532 (FIG. 5E) is displayed, actuating an icon or button provided on the device machine 110, or the like. In response, the item matching module 306 is configured to increment to the next matching tradeable item (block 436) and present that tradeable item on the device machine 110 (returns to block 416). Otherwise the device machine 110 is configured to wait for a command from the first user (no branch 438).

The device machine 110 is further configured to receive a trade request command from the first user (block 440 and yes branch 444). If no trade request command is received, the device machine 110 is configured to wait for a command from the first user (no branch 442). Once the device machine 110 receives the first user's selection of at least one of the matching tradeable items for trade with the first user's submitted item, a trading module 308 is configured to facilitate generating and transmitting a trade request message (block 446). (The trade request message is also referred to as a barter request message or an item exchange request message.) In some embodiments, the trading module 308 in conjunction with a communication module 310 are configured to automatically generate and transmit an electronic message to the owner of the selected tradeable item (referred to as a second user at a second device), in response to receiving the first user's selection of a particular tradeable item (or some other indication from the first user to initiate an exchange of that item). The electronic message conveys the trade request from the first user for the second user's tradeable item in exchange for the first user's submitted item, and includes the necessary item information about the first user's submitted item, obtained from the database of items. The electronic message comprises, but is not limited to, electronic mail (email), instant messaging (IM), short message text (SMS), text messaging, and the like. FIG. 5G illustrates an example trade request screen 540, in which the device machine 110 received the first user's selection of a particular tradeable item to be traded (not shown), and the corresponding trade request has been sent in an email (trade request confirmation notification 542). FIG. 5G shows that the first user has selected the items corresponding to the item image 533.

Next at a block 448, the device machine 110 receives a reply to the trade request message from the second user's second device (e.g., device machine 112). The reply comprises either an acceptance or a denial. The reply is provided in the same message type as the trade request message. For example, if the trade request message comprises an email, so too is the reply message. As discussed in detail below with respect to FIG. 4C, a denial reply can be automatically generated by the second user's device in response to the second user accepting a trade request made by a third user—each of the first user and the third user having made a trade request to the second user for the same second user's item. The first user can communicate back-and-forth with the second user via the communication module 310 after receiving the acceptance reply message. For example, the first and second users may wish to continue communications after the reply message to decide upon a mutually convenient meeting time and place to exchange the submitted item and the selected tradeable item with each other. Such exchange may also facilitate a friendship between the first and second users.

FIG. 4C illustrates a portion of the flow diagram 400 associated with replying to a trade request message. FIG. 4C continues to describe the barter mechanism accessed on the device machine 110, and the interaction between the device machine 110 and the first user. Blocks 450-458 occurs when one or more of users other than the first user (e.g., second user, third user, etc.) have submitted their respective items, requested items matching (or nearly matching) their respectively submitted items, at least one of the matching items is the first user's submitted item discussed above, and one or more trade request messages concerning the first user's submitted item are transmitted to the first user. These are the same implementation process as described above for the first user, except they are carried out with respect to one or more users other than the first user.

At a block 450, a trade request message concerning the first user's submitted item generated by each of the second user, third user, etc. (one trade request message per interested user) is provided to the first user on the device machine 110. The trading module 308 is configured to facilitate presentation of the received trade request message(s). FIG. 5H illustrates an initial trade request reply screen 550, the screen 550 including a list of the first user's submitted item(s) or a list of the first user's submitted item(s) for which there is at least one outstanding trade request message. Each of the submitted item(s) in the list can include an image of the item and a brief descriptor of the item, such as the item name previously entered during item submission. The list can comprise one or more items. In the case of FIG. 5H, a single submitted item—“kettle”—is listed. When the first user indicates interest in the kettle item, a detail trade request reply screen 552 (FIG. 5I) is provided on the device machine 110. The first user's indication of interest comprises any one of, but is not limited to, shaking the device machine 110, touching the portion of the touch screen of the device machine 110 corresponding to the kettle list item, making a sliding touching motion (to the right) on the touch screen corresponding to the kettle list item, and the like.

The detail trade request reply screen 552 of FIG. 5I comprises a UI screen providing the trade requests to exchange the first user's submitted item (e.g., “kettle”) with respective other users' items. FIG. 5I shows four trade requests for the kettle item, each from a different user.

Next at a block 452, the trading module 308 is configured to provide UI options for the first user to view and decide between the received trade requests. For instance, the first user can obtain information about a given item proposed as a trade for the first user's kettle item. If the first user indicates interest in any one of the trade requests 554, 556, 558, or 560 (e.g., touches one of these trade requests), then the device machine 110 displays a new screen (or a pop up screen overlaid over the screen 552) providing information about the item proposed as a trade in that trade request. FIG. 5J shows an item detail screen 562 including an item image 564 and an item description 566 for a “cup” item. The item image 564 and item description 566 are obtained from the items database previously populated by the owner of the “cup” item during item submission into the barter mechanism. The first user can similarly view item information about each of the received trade requests.

Once the first user accepts a particular one of the trade requests—such as by actuating the “accept” icon or button for a given one of the trade requests 554, 556, 558, or 560 (FIG. 5I)) or shaking the device machine 110 when the item detail screen 562 of a particular trade request is being displayed—the device machine 110 has also received selection of the particular tradeable item to trade with the first user's submitted item (e.g., kettle) (block 454).

In response, the trading module 308 and/or communication module 310 is configured to generate and transmit a reply (acceptance) message to the sender of the selected trade request in block 456. In some embodiments, the reply message can be automatically generated with standard language and transmitted without first user's input. In other embodiments, the reply message can be provided to the first user partially completed (such as the To, From, and Subject lines and standard acceptance language already included) with the option for the first user to edit the message before transmitting. The first user may, for example, propose a meeting time and place to make the exchange, have questions about the item, or impose condition(s) regarding the trade. FIG. 5K shows an example reply message started in a screen 570 in response to the first user selecting the trade request 556 (FIG. 5I) (or the proposed trade item in the trade request 556). When the first user completes composing the message and actuates the “send” icon or button in screen 570, this reply message is sent to the owner of the trade request 556 (e.g., the second user).

Lastly in a block 458, with one of the trade requests accepted, the device machine 110 is configured to automatically generate and transmit “deny” reply messages for the remaining trade requests. Continuing the above example, since the trade request 556 was accepted, the remaining trade requests (trade requests 554, 558, 560) are deemed to be denied and the owners of those trade requests are notified accordingly.

Note that in block 452, even if the first user deems one of the trade requests to be denied, as long as none of the trade requests has been accepted, the remaining trade requests remain as outstanding offers (at least for a certain time period). For example, if in FIG. 5I the first user actuates the “deny” icon or button for the trade request 554 but there has been no actuation of an “accept” icon or button for any of the trade requests 554, 556, 558, 560, then a deny reply message is sent with respect to the denied trade request 554 but no message is generated for the remaining trade request 556, 558, 560. The first user can continue to narrow down the trade requests by actuating one “deny” icon or button at a time, or actuate a given one of the “accept” icon or button.

It is contemplated that one or more blocks of FIGS. 4A-4C may be implemented differently than shown within the scope of embodiments of the present disclosure. For example, block 406 can be performed simultaneously with blocks 404 or 408, or block 406 can occur after block 408. As another example, block 450 can be performed prior to or simultaneously with block 412.

In this manner, a mechanism is provided for a plurality of users to barter, exchange, or trade goods and/or services with each other. One item may be exchanged for one or more items in a given barter transaction. Conversely a plurality of items may be exchanged for another plurality of items in a given barter transaction. Each party in a potential barter transaction determines the intrinsic value of the items proposed to be exchanged to him or her—one person's trash is another person's treasure—to complete an exchange. The delivery method of the mechanism also facilitates introductions, meetings, and relationship development between persons that otherwise may never cross paths with each other.

In some embodiments, the barter mechanism is configured to receive a user's submission of an item that he/she wishes to trade with another item. The user may trade, exchange, or barter his/her item for one or more items submitted by another user. The resulting item entry may comprise one or more fields of information about the item (e.g., including the geo-location information, item information, item image, and association with the user's identifier or user's contact information) for later use. The item entry may be stored locally at the client machines 110, 112 or at a remote database such as databases 126. Each item eligible for trade with another item is submitted to the system in this manner. The mechanism further provides a fun way to issue various user commands using the same interactive element, namely shaking the device at certain process points of the barter mechanism.

Once the user has submitted his/her item, the user can look for matching item(s) to trade with. The user may indicate a match request in any number of ways. In one embodiment, the user may shake his mobile device and the application recognizes the movement as a user request to provide matching items for viewing. In another embodiment, the user may actuate a button on the device to initiate a search for matching items. In still another embodiment, the user may touch an icon on a touch screen of the device to initiate a search for matching items. As shown in FIG. 4B, the user can view one or more items found to match his/her submitted item, review additional information about a particular tradeable item, and/or initiate a trade request for a particular tradeable item. To determine the matching item(s), the mechanism, in one embodiment, searches the database of item entries based on pre-determined criteria such as, but not limited to, similar color, size, price/value, random selection, or semi-random selection.

Once the user has found a tradeable item that he/she wishes to trade for his submitted item, the mechanism is configured to facilitate communication with the owner of the particular tradeable item to complete the trade. The owner is provided not only with the user's trade request itself, but interface and information options to sort through trade requests made by a plurality of other users for the tradeable item to accept or decline the trade request(s). The owner of the tradeable item views the trade requests and navigates through the trade requests also using a device (e.g., client machines 111, 112) similar in experience to that of the user. These features can be included in the same application that the user (on his device) interacts with to submit an item for trade and obtain matching items to trade with.

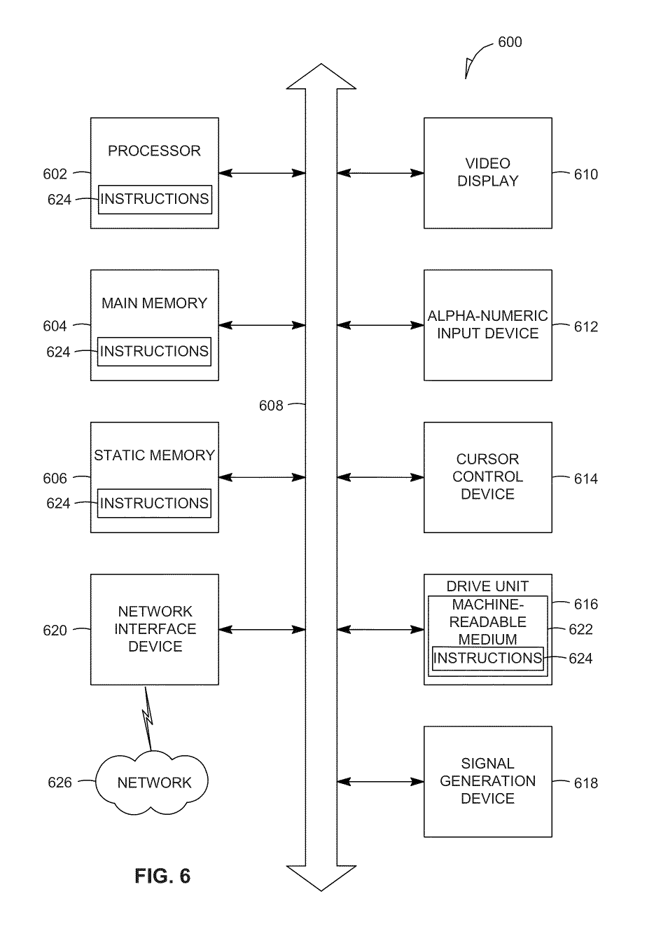

FIG. 6 shows a diagrammatic representation of a machine in the example form of a computer system 600 within which a set of instructions, for causing the machine to perform any one or more of the methodologies discussed herein, may be executed. The computer system 600 comprises, for example, any of the device machine 110, device machine 112, applications servers 118, API server 114, web server 116, database servers 124, or third party server 130. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet, a set-top box (STB), a Personal Digital Assistant (PDA), a smart phone, a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU), or both), a main memory 604 and a static memory 606, which communicate with each other via a bus 608. The computer system 600 may further include a video display unit 610 (e.g., liquid crystal display (LCD), organic light emitting diode (OLED), touch screen, or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker) and a network interface device 620.

The disk drive unit 616 includes a machine-readable medium 622 on which is stored one or more sets of instructions 624 (e.g., software) embodying any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media.

The instructions 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

It will be appreciated that, for clarity purposes, the above description describes some embodiments with reference to different functional units or processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), non-transitory, or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

Although the present invention has been described in connection with some embodiments, it is not intended to be limited to the specific form set forth herein. One skilled in the art would recognize that various features of the described embodiments may be combined in accordance with the invention. Moreover, it will be appreciated that various modifications and alterations may be made by those skilled in the art without departing from the spirit and scope of the invention.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method for facilitating an exchange of a first item with a second item, the method comprising:
receiving, at a first device, a request for one or more matching items to be exchanged with the first item;
presenting the one or more matching items presently available for exchange, the matching items identified based on one or more characteristics of the first item and pre-determined criteria;
in response to receiving a selection of the second item from among the matching items, automatically generating a trade request message requesting an exchange of the first item for the second item, wherein the trade request message is generated on behalf of a first user associated with the first item; and
transmitting the trade request message to a second user associated with the second item.

2. The method of claim 1, wherein the receiving the request for one or more matching items comprises detecting shaking of the first device.

3. The method of claim 1, further comprising:
receiving information about the first item to make the first item available for exchange, the identification including one or more characteristics of the first item;
obtaining geographical location information associated with the first item when the information about the first item is received; and
facilitating creating a first item entry associated with the first item, wherein the first item entry includes the information about the first item and the geographical location information.

4. The method of claim 1, further comprising:
providing a description of at least the second item prior to the second item being selected from among the matching items, and wherein the trade request message identifies the first item, the second item, and the first user.

5. The method of claim 1, further comprising receiving at least one reply message in response to the trade request message, wherein the reply message is provided by the second user.

6. The method of claim 5, wherein the reply message comprises one of an acceptance of the exchange request or a denial of the exchange request.

7. The method of claim 6, wherein when the reply message comprises the acceptance of the exchange request, automatically generating a denial reply message for each of other trade request messages requesting an exchange of respective items for the second item.

8. The method of claim 1, wherein the pre-determined criteria comprises a geographical location.

9. The method of claim 1, wherein the pre-determined criteria comprises a geographical location and one or more of size, value, color, classification, and skill.

10. The method of claim 1, wherein the pre-determined criteria comprises random selection.

11. The method of claim 1, wherein each of the first item and the second item comprises a good or a service.

12. A device, comprising:
a display;
at least one memory;
at least one processor in communication with each of the memory and the display; and
one or more modules comprising instructions stored in the memory and configured for execution by the processor, the modules comprising:
a first module configured to receive a request for one or more matching items to be exchanged with a first item;
a second module configured to present the one or more matching items presently available for exchange, the matching items identified based on one or more characteristics of the first item and pre-determined criteria;
a third module configured, in response to receiving a selection of a second item from among the matching items, automatically generating a trade request message requesting an exchange of the first item for the second item, wherein the trade request message is generated on behalf of a first user associated with the first item; and
a fourth module configured to transmit the trade request message to a second user associated with the second item.

13. The device of claim 12, wherein the first module is configured to detect shaking of the device as the received request for the matching items.

14. The device of claim 12, wherein the modules further comprise:
a fourth module configured to receive information about the first item to make the first item available for exchange, the identification including one or more characteristics of the first item;
a fifth module configured to obtain geographical location information associated with the first item when the information about the first item is received; and
a sixth module configured to facilitate creation of a first item entry associated with the first item, wherein the first item entry includes the information about the first item and the geographical location information.

15. The device of claim 12, wherein the modules further comprise a seventh module configured to provide a description of at least the second item prior to the second item being selected from among the matching items, and wherein the trade request message identifies the first item, the second item, and the first user.

16. The device of claim 12, wherein the modules further comprise an eighth module configured to receive at least one reply message in response to the trade request message, wherein the reply message is provided by the second user.

17. The device of claim 16, wherein the reply message comprises one of an acceptance of the exchange request or a denial of the exchange request.

18. The device of claim 12, wherein the pre-determined criteria comprises at least one of a geographical location, a random selection, or the geographical location and one or more of size, value, color, classification, and skill.

19. The device of claim 12, wherein the device comprises at least one of a mobile device, a smart phone, a tablet, a cellular phone, a laptop, a computing device.

20. A non-transitory computer readable medium including instructions, when executed by a processor, causes the processor to perform operations comprising:
receiving a request for one or more matching items to be exchanged with a first item;
presenting the one or more matching items presently available for exchange, the matching items identified based on one or more characteristics of the first item and pre-determined criteria;
in response to receiving a selection of a second item from among the matching items, automatically generating a trade request message requesting an exchange of the first item for the second item, wherein the trade request message is generated on behalf of a first user associated with the first item; and
transmitting the trade request message to a second user associated with the second item.

21. The non-transitory computer readable medium of claim 20, wherein the receiving of the request for one or more matching items comprises detecting a pre-determined movement of a device on which the request is made.

22. The non-transitory computer readable medium of claim 20, further comprising:
receiving information about the first item to make the first item available for exchange, the identification including one or more characteristics of the first item;
obtaining geographical location information associated with the first item when the information about the first item is received; and
creating a first item entry associated with the first item, wherein the first item entry includes the information about the first item and the geographical location information.

23. The non-transitory computer readable medium of claim 20, further comprising:
providing a description of at least the second item prior to the second item being selected from among the matching items, and wherein the trade request message identifies the first item, the second item, and the first user.

24. The non-transitory computer readable medium of claim 20, further comprising receiving at least one reply message in response to the trade request message, wherein the reply message is provided by the second user.

25. The non-transitory computer readable medium of claim 20, wherein the pre-determined criteria comprises at least one of a geographical location, a random selection, or the geographical location and one or more of size, value, color, classification, and skill.

26. A method for facilitating an exchange of a first item with a second item, the method comprising:
receiving a request for one or more matching items to be exchanged with the first item;
identifying the one or more matching items presently available for exchange, the matching items identified based on one or more characteristics of the first item and pre-determined criteria;
transmitting, to a device from which the request for the matching items was made, the identified matching items;
in response to receiving, from the device, a selection of the second item from among the matching items, automatically generating a trade request message requesting an exchange of the first item for the second item, wherein the trade request message is generated on behalf of a first user associated with the first item; and
transmitting the trade request message to a second user associated with the second item.

27. The method of claim 26, wherein the pre-determined criteria comprises at least one of a geographical location, a random selection, or the geographical location and one or more of size, value, color, classification, and skill.

28. The method of claim 26, further comprising:
receiving information about the first item to make the first item available for exchange, the identification including one or more characteristics of the first item;
receiving geographical location information associated with the first item when the information about the first item is received; and
creating a first item entry associated with the first item, wherein the first item entry includes the information about the first item and the geographical location information.

29. The method of claim 26, further comprising transmitting a description of at least the second item, in response to a request for the description, and wherein the trade request message identifies the first item, the second item, and the first user.

30. The method of claim 26, further comprising receiving at least one reply message in response to the trade request message, wherein the reply message is provided by the second user.

31. The method of claim 30, wherein when the reply message comprises the acceptance of the exchange request, automatically generating a denial reply message for each of other trade request messages requesting an exchange of respective items for the second item.

32. The method of claim 26, wherein the pre-determined criteria comprises at least one of a geographical location, a random selection, or the geographical location and one or more of size, value, color, classification, and skill.
